(19) United States
(12) Patent Application Publication
(10) Pub. No.: US 2009/0244143 A1
(43) Pub. Date: Oct. 1, 2009

(54) INKJET PRINTER AND METHOD THEREOF FOR REGULATING PRINTING REGION

(75) Inventor: Ying-Chieh Huang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: KINPO ELECTRONICS, INC., Taipei County (TW)

(21) Appl. No.: 12/141,930

(22) Filed: Jun. 19, 2008

(30) Foreign Application Priority Data
Mar. 26, 2008 (TW) 97110824

(51) Int. Cl. B41J 29/38

(52) U.S. Cl. 347/14; 347/16

(57) ABSTRACT

An inkjet printer and a method thereof for regulating a printing region are disclosed. The above-mentioned inkjet printer includes a paper-feeding device, a detecting device, a printer controller and an ink-jetting device. As the paper-feeding device feeds a paper, the detecting device detects the skew angle of the paper, and then, the printer controller expands the printing region for printing according to the skew angle of the paper and a look up table.

### CROSS-REFERENCE TO RELATED APPLICATION

This application claims the priority benefit of Taiwan application serial no. 97110824, filed on Mar. 26, 2008. The entirety of the above-mentioned patent application is hereby incorporated by reference herein and made a part of specification.

### BACKGROUND OF THE INVENTION

1. Field of the Invention

The present invention generally relates to a printer, and more particularly, to an inkjet printer and a method thereof for automatically regulating a printing region.

2. Description of Related Art

Along with the gradually reduced cost and the quality printing effect of a laser printer and an inkjet printer, the laser printer and the inkjet printer have become an indispensable electronic product for a person or a family. In particular, in terms of photo quality, it now can match the professional level of a photo developing and printing shop. Indeed, a personal photo or a color/black-white image printed by a laser printer or an inkjet printer has colors near to the real and vivid ones. Besides, an interface with a high transmission speed available today easily speeds up a printing job of a photo with a large-size and a high resolution and thereby provides more convenience to the user and higher efficiency for printing a quality photo.

However, as a generic printer picks up a paper sheet, the fed paper sheet is often placed on the skew due to the nonconformances of mechanical structure and paper property. In order to correct the skew of paper sheets, the paper-feeding device of a printer has an adjusting function of paper orientation, so that the orientation of the paper can be corrected by repeatedly drawing the paper; but due to the process nonconformance of the printer assembly composed of a lot of parts, the skew of paper sheets can not be completely corrected. In particular, for full page printing mode (usually corresponding to printing a photo), a white-edge artifact (a not-printed blank area occurring at the edge of a paper) likely occurs at the paper boundary. In other words, the original picture fails to be printed on a paper sheet, which produces a poor photo.

### SUMMARY OF THE INVENTION

Accordingly, the present invention is directed to an inkjet printer and a method thereof for regulating a printing region. The printer and method are able to adjust the printing distance beyond page during printing according to the skew angle of a printed paper so as to avoid a white-edge artifact and ink contamination.

To achieve the above-mentioned or other objectives, the present invention provides an inkjet printer, which includes a paper-feeding device, a detecting device, a printer controller and an ink-jetting device, wherein the detecting device detects a skew angle of the printed paper as the paper-feeding device feeds a paper sheet. The printer controller is used to control the paper-feeding device and the detecting device, and determines a printing distance beyond page according to the skew angle and a look up table (LUT). The ink-jetting device is coupled to the printer controller and expands the printing region according to the determined distance beyond page and then conducts printing.

In an embodiment of the present invention, the above-mentioned inkjet printer magnifies the dimension of an original picture so as to expand the printing region of the ink-jetting device according to the distance beyond page.

In an embodiment of the present invention, the above-mentioned detecting device detects the boundary position change of the paper for calculating the skew angle of the paper as the paper-feeding device repeatedly draws the paper to avoid paper jams.

In an embodiment of the present invention, the above-mentioned LUT contains the relationships between skew angles and distances beyond page.

In an embodiment of the present invention, the above-mentioned paper is a paper sheet.

The present invention also provides a method for regulating a printing region. The method includes the following steps. First, a skew angle of the paper during conducting a paper-feeding operation on a paper is detected. Next, a distance beyond page is determined according to the skew angle and an LUT. Next, the printing region for printing is expanded according to the distance beyond page.

In an embodiment of the present invention, the LUT herein contains a plurality of relationships between skew angles and distances beyond page, and the LUT is stored in the printer controller.

In an embodiment of the present invention, the above-mentioned step of expanding the printing region for printing according to the distance beyond page further includes magnifying the dimension of an original picture so as to expand the printing region.

In an embodiment of the present invention, the above-mentioned step of detecting the skew angle of the paper further includes sliding the paper and detecting the boundary position change of the paper so as to calculate the skew angle of the paper.

In summary, the present invention dynamically regulates the printing region according to the skew angle of the paper. Therefore, even though different skew angles are presented due to the non-conformances of mechanical structure of the printer, the present invention still can appropriately expands the dimension of the original picture by obtaining a proper distance beyond page, which would simultaneously avoid white-edge artifact and improve ink contamination.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an inkjet printer according to the first embodiment of the present invention.

FIG. 2 is a diagram showing a distance beyond page according to the first embodiment of the present invention.

FIG. 3 is a diagram showing a paper-feeding operation according to the second embodiment of the present invention.

FIG. 4 is a flowchart of regulating the printing region according to the second embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### The First Embodiment

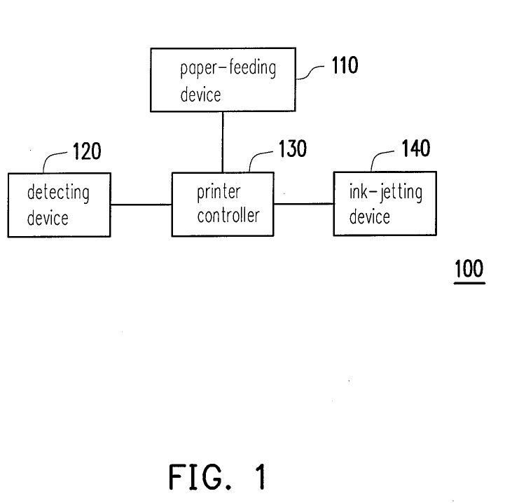

FIG. 1 is a block diagram of an inkjet printer according to the first embodiment of the present invention. The inkjet printer 100 includes a paper-feeding device 110, a detecting device 120, a printer controller 130 and an ink-jetting device 140. The printer controller 130 is coupled to the paper-feeding device 110, the detecting device 120 and the ink-jetting device 140 for controlling the printing operations of the entire printer.

The paper-feeding device 110 usually includes mechanical structures such as a pick up roller, a feeding roller and a pinch roller, and is mainly in charge of paper-feeding operations on a paper (for example, paper sheet). The detecting device 120 is usually integrated onto a carriage of an ink cartridge for detecting the edge positions of the paper and the position of the ink cartridge. As the paper-feeding device 110 conducts a paper-feeding operation on the paper, the detecting device 120 detects a skew angle of the paper, where the edge positions of two points of the paper sheet are measured during paper-feeding, the skew angle between the paper sheet and a preset paper-feeding track of the inkjet printer 100 can be derived. The skew angle is a paper-feeding angle deviation caused by errors of machine and tool or other sources during paper-feeding. Note that in order to avoid carrying more than one paper to cause paperjams during paper-feeding, the paper-feeding device 110 would back-and-forth draw the papers, and at the time, the detecting device 120 would calculate the skew angle of the paper according to the changes of edge positions of the paper.

The printer controller 130 has a look-up table (LUT), wherein a plurality sets of relationships between skew angles and distances beyond page is stored. For example, the distance beyond page is set as 0.5 mm corresponding to 1° of skew angle. The data of the LUT, i.e., the relationships between skew angles and distances beyond page are set corresponding to different paper and different inkjet printer types, which the present invention is not limited to. When the detecting device 120 obtains a skew angle, the printer controller 130 would determine a distance beyond page according to the skew angle and the LUT. The ink-jetting device 140 then expands the printing region according to the distance beyond page for printing. In this way, the white-edge artifact at the edges of a paper (i.e., there are unprinted blank areas at the edges of a paper sheet) during conducting a full page printing can be avoided.

So-called distance beyond page means the space between the edge of a printing region and the corresponding edge of a paper with a size less than the printing region. The most direct way to establish a distance beyond page is by expanding the dimension of the original picture so as to make the printing region greater than the paper. At this time, since the printing region occupies a greater area, the printing region can cover the whole sheet to be printed during printing, and a satisfied printing effect is achieved. Alternatively, all the printing can be conducted under a fixed distance beyond page, which is easier, but a greater distance beyond page is required to suit different skew angles. Therefore, the method with a fixed distance beyond page is easy to cause wasting ink and ink contamination, even leads to a fault or a damage inside the printer. In short, the embodiment automatically adjusts the distance beyond page in response to a skew angle, which not only avoids producing white-edge artifact, but also lightens the ink contamination problem due to an excessive distance beyond page.

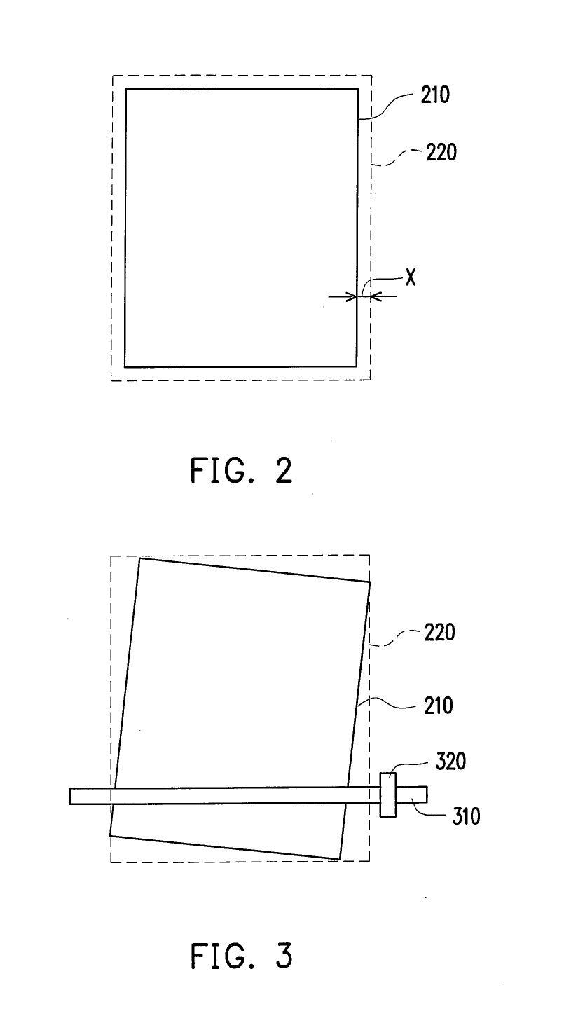

FIG. 2 is a diagram showing a distance beyond page according to the first embodiment of the present invention. Referring to FIG. 2, the relationship between the above-mentioned distance beyond page and printing region is explained in more detail. The paper 210 in FIG. 2 is represented by solid lines, the printing region 220 is represented by dotted lines and the distance beyond page X indicated the greater space distance of the edge of the printing region 220 than the edge of the paper 210. During paper-feeding, possible errors of the mechanical device may produce a skew, as shown in FIG. 3. FIG. 3 is a diagram showing a paper-feeding operation according to the second embodiment of the present invention, wherein the detecting device 120 is usually integrated onto an ink cartridge holder 320 on the carriage 310. The detecting device 120 detects the skew angle of the paper 210, then the printer controller 130 determines a proper distance beyond page X according to the detected skew angle and the LUT, where the greater the skew angle, the greater the distance beyond page X is. As shown in FIG. 3, when the paper 210 deviates the original preset paper-feeding track, due to the expanded printing region 220, the inkjet printer 100 still can print the whole page of the paper 210 without leaving a white-edge artifact (blank area).

Note that the carriage 310 and the ink cartridge holder 320 in FIG. 3 of the embodiment are disposed in the ink-jetting device 140, while the ink-jetting device 140 is able to adjust the setting angle of the carriage 310 according to the skew angle of the paper 210, so that the printing direction of the ink cartridge holder 320 can be adjusted, which makes the over-position between the printing region 220 and the paper 210 better, reduces the distance beyond page X and meanwhile avoids or reduces the risk of producing white-edge artifact and ink contamination.

### The Second Embodiment

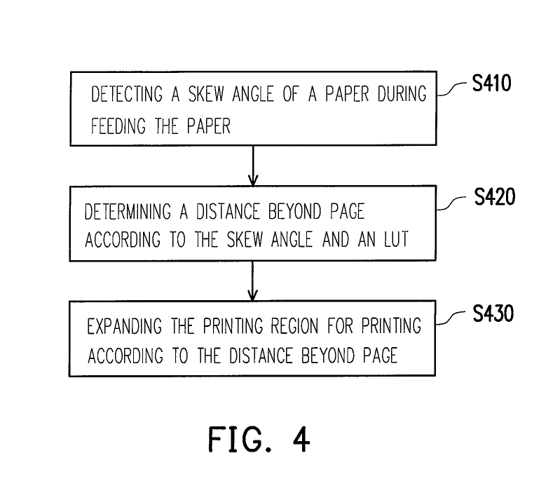

According to the implementations of the above-described first embodiment, a method for regulating a printing region is extracted. FIG. 4 is a flowchart of regulating the printing region according to the second embodiment of the present invention. The method is described with reference to FIG. 4. First, a skew angle of a paper is detected during feeding the paper (step S410). Next, a distance beyond page is determined according to the skew angle and an LUT (step S420). Next, the printing region for printing is expanded according to the distance beyond page (step S430). The LUT herein contains the relationships between various skew angles and distances beyond page.

In another embodiment of the present invention, the step S410 further includes drawing the paper and detecting the changes of edge positions of the paper for calculating a skew angle. The step S430 further includes magnifying the dimension of an original picture for expanding the printing region. Other details of the second embodiment can be referred to the description of the first embodiment, which are omitted for simplicity.

In summary, since the present invention adjusts the size of a printing region according to the skew angle of a paper, therefore, the distance beyond page of the inkjet printer would not be excessive. In this way, the present invention not only avoids producing white-edge artifact during a full page printing, but also lightens the ink contamination problem caused by expanding the printing region.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inkjet printer, comprising:
a paper-feeding device, for feeding a paper;
a detecting device, for detecting a skew angle of the paper as the paper-feeding device feeding the paper;
a printer controller, for controlling the paper-feeding device and the detecting device and determining a distance beyond page according to the skew angle and a look up table; and
an ink-jetting device, coupled to the printer controller, for expanding a printing region according to the determined distance beyond page and then conducting printing.

2. The inkjet printer according to claim 1, wherein the inkjet printer magnifies the dimension of an original picture so as to expand the printing region of the ink-jetting device according to the distance beyond page.

3. The inkjet printer according to claim 1, wherein the detecting device detects the changes of edge positions of the paper for calculating the skew angle of the paper as the paper-feeding device repeatedly draws the paper to avoid paper jams.

4. The inkjet printer according to claim 1, wherein the look up table contains relationships between the skew angles and the distances beyond page.

5. The inkjet printer according to claim 1, wherein the paper comprises a paper sheet.

6. The inkjet printer according to claim 1, wherein the ink-jetting device further adjusts a printing direction according to the skew angle of the paper.

7. A method for regulating a printing region, comprising:
detecting a skew angle of a paper during feeding the paper;
determining a distance beyond page according to the skew angle and a look up table; and
expanding the printing region for printing according to the distance beyond page.

8. The method for regulating a printing region according to claim 7, wherein the look up table contains relationships between skew angles and distances beyond page.

9. The method for regulating a printing region according to claim 7, wherein the look up table is stored in the printer controller.

10. The method for regulating a printing region according to claim 7, wherein the step of expanding the printing region for printing according to the distance beyond page further comprises magnifying the dimension of an original picture so as to expand the printing region.

11. The method for regulating a printing region according to claim 7, wherein the step of detecting the skew angle of the paper further comprises drawing the paper and detecting the position change of an edge of the paper so as to calculate the skew angle of the paper.

12. The method for regulating a printing region according to claim 7, wherein the paper comprises a paper sheet.

13. The method for regulating a printing region according to claim 7, further comprising:
adjusting a printing direction according to the skew angle of the paper.
